(19) United States
(12) Patent Application Publication
(10) Pub. No.: US 2007/0036945 A1
(43) Pub. Date: Feb. 15, 2007

(54) Masking film for textured surfaces

(75) Inventors: Gary Balakoff, Orwigsburg, PA (US); Paul Stecher, Chesterfield, VA (US); Beth Powell, Orwigsburg, PA (US)

Correspondence Address: JOSEPH A TESSARI;TREDEGAR FILM PRODUCTS, 1100 BOULDERS PARKWAY, RICHMOND, VA, 23225, US

(73) Assignee: Tredegar Film Products Corporation, Richmond, VA (US)

(21) Appl. No.: 11/503,441

(22) Filed: Aug. 11, 2006

Related U.S. Application Data
(62) Division of application No. 10/601,581, filed on Jun. 24, 2003.

(51) Int. Cl. G11B 5/64

(52) U.S. Cl. 428/141

(57) ABSTRACT

A method of removably adhering a masking film to a textured surface having a surface roughness greater than about 150 Ra, the film having a first side with a smooth, non-coated adhesive surface comprising from about 30 wt. % to about 80 wt. % of at least one thermoplastic elastomer having saturated rubber mid-blocks selected from the group consisting of styrene-ethylene/butylene-styrene, styrene-ethylene/propylene-styrene, styrene-ethylene/butylene, and styrene-ethylene/propylene, and a second side having a rough surface.

### BACKGROUND OF THE INVENTION

1. Field of the Invention

The present invention relates to a masking film that adheres to textured surfaces and that can be removed readily from the surfaces, even after heating and aging. The masking film preferably is adhered to the textured surface without the need for an adhesive coating. The invention also relates to a method for producing the masking film that adheres to textured surfaces.

2. Description of Related Art

Masking films protect surfaces by acting as physical barriers to prevent contamination, scratching, scuffing and marring of the surface. The protection provided by masking films is particularly useful while these surfaces are being transported or handled prior to use. Masking films are used in numerous applications as protective coverings for surfaces, particularly relatively smooth surfaces, such as acrylics, polycarbonates, glass, polished or painted metals and glazed ceramics. Textured surfaces are typically more challenging because they require either a greater flow of adhesive or a more aggressive adhesive coating. To provide a greater flow of adhesive, a greater amount of adhesive coating or a lower viscosity adhesive is required to fill and bridge gaps. These adhesive coatings are much more susceptible to squeeze out and adhesive failure. Using a more aggressive adhesive, however, may damage the areas of contact upon removal or leave an undesirable residue.

Traditionally, surface protection has been provided via corona-treated films or adhesive-coated paper and film. Corona-treated films have been exposed to an electrostatic discharge to oxidize the surface of the film. This oxidation increases the film's surface tension and attraction to polar surfaces. Such corona-treated films typically are non-embossed and rely on a very narrow window of corona treatment to facilitate adhesion. The non-embossing makes the film subject to hard wrinkles and gels. The corona treatment also dissipates with time. Overall, the adhesion level of corona-treated films is too low to provide adhesion to textured surfaces.

To achieve adhesion to textured surfaces, an adhesive coating has historically been required. Adhesive-coated paper, unfortunately, is susceptible to moisture from both humidity and liquids, which permeate the paper and loosen or completely separate the masking material from the surface to be protected. Adhesive-coated films are not as susceptible to moisture and can be made transparent for visual inspection. To be removable, these films typically have adhesion values less than 2 lbs./in (907 g/in) peel adhesion. Pressure-sensitive adhesives, by definition, are permanently tacky and retain the properties of flow, high viscosity and elasticity over their useful life. Although pressure-sensitive adhesive coatings have been used successfully, exposure to heat or extended aging during transportation and storage can escalate adhesion. Modifiers can be used to counteract this escalation, but these modifiers can migrate and contaminate the protected surfaces. Heat and aging also can lead to the migration of tackifiers, surfactants, defoamers, plasticizers and residual solvent, which can contaminate the surface. Similar to corona-treated masking, the non-embossed, adhesive-coated masking films also are subject to hard wrinkles and gels. Finally, adhesive coatings require the additional steps involved in applying the adhesive coating to the preformed film, (e.g., compounding, coating, curing, crosslinking, drying, etc.).

In removable masking, adhesion should fail cleanly between the protected surface and the adhesive at a desired peel force (adhesive failure). An elevated adhesion level can damage delicate substrates or coatings (substrate failure) or make the masking film impossible to remove. The adhesive itself also could split (cohesive failure) and require the use of a solvent to remove the residual adhesive. This residual adhesive is of particular concern where the surface being protected is to be used in electronics, optics or the food industry.

Advances in masking film technology have produced masking films formed without corona treatment or the use of adhesive coatings, including one side matted (“OSM”) masking films. Such OSM films are more fully described in U.S. Pat. Nos. 4,895,760 and 5,100,709, both assigned to Tredegar Industries, Inc., Richmond, Va., the disclosures of which are incorporated by reference herein in their entirety. These masking films rely upon the tendency of very smooth surfaces to adhere to each other. Thus, these films do not adhere to textured surfaces.

Multilayer masking films also have been coextruded with pressure-sensitive adhesive, as described in U.S. Pat. Nos., 5,286,781 and 5,427,850 assigned to Sekisui Chemical Co., Ltd., Osaka, Japan, the disclosures of which are incorporated by reference herein in their entirety. These films use styrene-butadiene-styrene (SBS), styrene-isoprene-styrene (SIS), styrene-butadiene (SB), and styrene-isoprene (SI) block copolymers. These block copolymers have poor heat and aging stability due in part to the presence of double bonds. These films also contain anti-blocking agents (extender oil, polyethyleneimine) to provide good unwinding ability, to reduce the rise in tackiness and to prevent the film from laminating to itself while stored in rolls. The anti-blocking agent can migrate (bloom) with temperature and time to ultimately contaminate the substrate surface. Varying levels of anti-blocking agent also cause varying levels of adhesion to the substrate.

More recent advances in masking film technology have produced co-extruded, multilayer masking films with less temperature dependency. These OSM films are more fully described in U.S. Pat. Nos. 5,693,405; 6,040,046; and 6,326,801—all assigned to Tredegar Industries, Inc., Richmond Va., and all incorporated by reference herein in their entirety. These films, however, require a relatively smooth surface (0 to 150 Ra), and cannot adhere to textured surfaces, which, in contrast to smooth surfaces, typically have surface roughness values of from about 150 Ra to about 1,000 Ra. For example, styrene-ethylene-butylene-styrene (SEBS), and styrene-ethylene-propylene (SEP), and blends thereof are not capable of adhering to a textured surface. In addition, blends of Bynel/SEBS or Bynel/SEP (Bynel is an acid-modified ethylene acrylate available from DuPont) are incompatible with exposure to time and temperature and leave an undesirable residue on the substrate.

The present invention could also have interruptions or unembossed areas that form desirable patterns on the masking film as described in U.S. Pat. Nos. 5,693,405, assigned to Tredegar Industries, Inc, Richmond, Va. The patterned embossed material can comprise useful written information or artistic patterns.

There remains a need for a masking film capable of providing an adequate level of protection to textured surfaces by providing a functional, adjustable and controlled level of adhesion. This is accomplished without an adhesive coating and its associated disadvantages.

The description herein of certain advantages and disadvantages of known masking films, and methods of their preparation, is not intended to limit the scope of the present invention. Indeed, the present invention may include some or all of the methods and chemical reagents described above without suffering from the same disadvantages.

### SUMMARY OF THE INVENTION

In accordance with the present invention, there is provided a masking film that adheres to and provides protection for textured surfaces without the need for an adhesive coating. Additionally, the improved film is preferably of the one-side matte (OSM) type so that blocking and wrinkling of the film are substantially minimized, if not completely eliminated. The level of adhesion produced by the improved film is adjustable so as to accommodate a variety of substrate chemistries and topographies. For example, the improved masking film of the present invention can provide a functional level of adhesion to textured polycarbonate, acrylic, polyvinyl chloride, nylon, and polyester (PET, PETG, PEN) at room or ambient temperature. Accordingly, for virtually any given processing environment, including temperature and line equipment layout, and desired application, the improved masking film of the present invention can provide an adequate level of adhesion to the surface of interest. The improved masking film of the present invention also remains removably attached after aging and/or heating.

The improved masking film of the present invention comprises a film preferably having a first side with a smooth surface that does not have an adhesive coating, a second side having a rough surface, and optionally, one or more core layers interposed between the first side and the second side. The smooth side comprises at least one layer of a thermoplastic film, and is comprised of thermoplastic elastomers with saturated rubber mid-blocks selected from styrene-ethylene/butylene-stryene, styrene-ethylene/propylene-styrene, styrene-ethylene/propylene, styrene-ethylene/butylene, radial (styrene-butadiene)ₙ and radial (styrene-isoprene)ₙ as a primary component, where n is an integer of from about 1 to about 2000. In use, the smooth side is applied to the surface to be protected. The rough side is also comprised of at least one layer of a thermoplastic film.

According to another feature of an embodiment of the invention, there is provided a method of making a film having a first side with a smooth surface that does not have an adhesive coating, a second side having a rough surface, and optionally, one or more core layers interposed between the first side and the second side. The method includes selecting primary components to be used in forming the first side with a smooth surface. It is the smooth surface of this first side that will contact with and adhere to the rough surface of the substrate to be protected. Once selected, the relative percentage of the components are determined to produce a functional and controlled level of adhesion force produced for a given rough surfaced substrate.

The remaining rough surface of the second side and core layers, if present, are formed of suitable thermoplastic components that are selected based on desired stiffness, polarity, surface tension, heat resistance and chemical resistance. The respective components are then are preferably coextruded to form the masking film of the present invention. Due to the selection of the components and their relative amounts, the resulting masking film is tailored to perform in the given production environments under the given conditions.

### BRIEF DESCRIPTION OF THE DRAWINGS

FIG. 1 is a graph showing the peel adhesion of a film made in accordance with the present invention on velvet polycarbonate.

FIG. 2 is a graph showing the peel adhesion of a conventional pressure sensitive adhesive material on velvet polycarbonate.

FIG. 3 is a graph showing the peel adhesion of a film made in accordance with the present invention on suede polycarbonate.

FIG. 4 is a graph showing the peel adhesion of a conventional pressure sensitive adhesive material on suede polycarbonate.

### DETAILED DESCRIPTION OF THE PREFERRED EMBODIMENTS

Set forth below are definitions of some of the terms and expressions used herein.

The terms “substantially” and “about” means that a given property or parameter (such as the surface roughness) may vary by 30% from the stated value, and preferably by 20% from the stated value.

As used throughout this disclosure, the singular forms “a,” “an,” and “the” include plural reference unless the context clearly dictates otherwise. Thus, for example, a reference to “a compound” includes a plurality of such compounds, and a reference to “an ingredient” or “an additive” is a reference to one or more ingredients or additives and equivalents thereof known to those skilled in the art, and so forth.

Unless defined otherwise, all technical and scientific terms used herein have the same meanings as commonly understood by one of ordinary skill in the art to which this invention belongs. Although any methods and materials similar or equivalent to those described herein can be used in the practice of the present invention, the preferred methods, devices, and materials are now described. All publications mentioned herein are cited for the purpose of describing and disclosing the various films, compounds, compositions, methods, etc., that are reported in the publications and that might be used in connection with the invention. Nothing herein is to be construed as an admission that the invention is not entitled to antedate such disclosures by virtue of prior invention.

The term “film” refers to a web made by extruding a molten sheet of polymeric material by a cast or blown extrusion process and then cooling said sheet to form a solid polymeric web. Films can be monolayer films, coextruded films, coated films, and composite films. Coated films are films comprising a monolayer or coextruded film which are subsequently coated (extrusion coated, impression coated, printed) with a thin layer of the same or different material to which it is bonded and after bonding is incapable of separation. Composite films are films comprising more than one film where the at least two films are bonded in a bonding process. Bonding processes may incorporate adhesive layers between the film layers.

The masking film of the present invention includes a film having a first side having a smooth surface that does not have an adhesive coating, a second side having a rough surface, and optionally, one or more core layers interposed between the first side and the second side. The smooth side comprises at least one layer of a thermoplastic film, and is comprised of thermoplastic elastomers with saturated rubber mid-blocks selected from styrene-ethylene/butylene-stryene, styrene-ethylene/propylene-styrene, styrene-ethylene/propylene, styrene-ethylene/butylene, radial (styrene-butadiene)ₙ and radial (styrene-isoprene)ₙ as a primary component. In the above elastomers, n is an integer, and preferably an integer of from about 1 to about 2000. In use, the smooth side is applied to the surface to be protected, which preferably is a rough surface having a surface roughness of greater than about 150 Ra. The rough side is also comprised of at least one layer of a thermoplastic film. If only one layer is used, the one layer having a smooth and rough side preferably is extruded, whereas if multiple layers are used, the layers preferably are coextruded.

The rough side preferably is matte embossed, but can be roughened via any suitable means. The rough side is believed to prevent the film from contacting as much surface area of itself, or any other surface, thereby preventing blocking and wrinkling of the film. At least one core layer may be interposed between the smooth side and the rough side of the improved masking film and, if present, also may be comprised of a thermoplastic film. In the monolayer embodiment, the smooth side and rough side are opposing sides of a single layer of the film.

The level of adhesion produced between the smooth side of the masking film of the present invention and the textured surface to be protected is adjustable via the introduction of certain polymers and co-polymers associated with the smooth side of the film. The controlled combination of such polymers and co-polymers has the affect of adjusting the level of adhesion produced between the smooth side of the masking film and the surface to be protected. The surface chemistry and topography of the substrate dictate the identity and quantities of these polymers. Those skilled in the art are capable of varying the type and amount of polymers to achieve the desired adhesion, using the guidelines provided herein.

In certain embodiments of the invention, a one, two or multilayered masking film can be produced including suitable polymer and copolymer additives capable of adjusting the level of adhesion produced by the film. These films can be blown or cast. Additionally, in the multilayered embodiment, the layer including the smooth side of the improved masking film of the present invention may be laminated to the layer including the rough side, if desired. Blending of polymer and copolymer additives of the smooth side of the masking film can be controlled to produce the desired adhesion of the resulting masking film. Again, those skilled in the art are capable of selecting the appropriate additives, their respective concentrations, and mechanisms of incorporating them into the film, using the guidelines provided herein.

Preferably, the multilayer one-sided matte-embossed masking film is applied to a textured surface, with a roughness in the range of 150 Ra to 1000 Ra. Throughout this description, “smoothness” and “roughness” are defined as the arithmetic average height of the micropeaks and microvalleys of a surface to the centerline of such surface as measured by a profilometer. Smoothness and roughness defined in this manner typically are expressed in units of microinches (10⁻⁶ inches) (Ra). All testing of surface textures (relative smoothness and roughness) were conducted in accordance with ANSI/ASME Test Method B46.1-1985. Preferred textured surfaces include, by way of illustration only, polycarbonate, polyurethane, polyester, acrylic, polyvinyl chloride, nylon, PET, PETG, PEN, glass, ceramic, metal and various coatings. For example, textured polycarbonate film can be velvet (approximately 150 Ra) and suede (500-700 Ra). Prismatic polyester can have a roughness in the range of from about 200 to about 300 Ra. Vinyl floor tiles can have a roughness in the range of from about 150 to about 400 Ra.

In a preferred embodiment, the first layer includes a surface having a measure of smoothness between 0 Ra and 60 Ra, and more preferably, between 0 Ra and 30 Ra. The relatively rough surface of the second layer includes a measure of roughness between 20 Ra and 600 Ra, and more preferably, between 40 Ra and 200 Ra. Although measures of smoothness between 0 Ra and 30 Ra are preferred for the smooth surface, and measures between 40 Ra and 200 Ra are preferred for the rough surface, it is noted that the improved masking film may have virtually any level of relative smoothness or roughness and still prevent much of the blocking and wrinkling associated with traditional masking films.

Matte embossing (e.g., by extruding into a pair of nip rollers in which one roll is a polished chrome casting roll and the other roll is rubberized) is a preferred technique for imparting a sufficient level of roughness to the second layer. It should be noted that the roughening of the surface of the second layer might be accomplished via any suitable method including, without limitation, air impingement, air jets, water jets, and combinations thereof. The rough surface prevents blocking by precluding such intimate contact between the surfaces of the masking film and another surface such that the masking film can be easily unrolled and/or peeled away from another smooth surface. This feature also prevents the wrinkling so often associated with traditional masking films. The multilayer matte-embossed film layer also may incorporates mechanical differential slip as opposed to chemical (anti-blocking agent) induced differential slip.

In addition, although the preferred embodiment includes at least a first layer and a second layer, the relatively smooth side and the relatively rough side of the improved masking film of the present invention can be formed on opposite sides of a single layer of thermoplastic material, if desired. In such an embodiment, no core layers would be present. Single and multiple-layered masking films also can be made without a rough side by incorporating anti-blocking agents. In this regard, marginal amounts (up to about 8000 parts per million) of anti-blocking agents would be used.

Adjustment of the adhesion level produced in the present invention can be accomplished through the introduction of, and the percentage of certain polymers and co-polymers in the smooth side of the thermoplastic film. The preferred primary polymer associated with the smooth side of the first layer to affect the adhesion level produced is a styrene-ethylene/butylene-styrene (SEBS) block co-polymer, styrene-ethylene/butylene (SEB) block co-polymer, a styrene-ethylene/propylene-styrene (SEPS) block co-polymer, a styrene-ethylene/propylene (SEP) block co-polymer, or blends thereof, such as Kraton-G® and functionalized Kraton-G®, commercially available from Kraton Polymers, Houston, Tex. The primary block co-polymer component percentage range would be 30% to 85%, with a more preferred range of 35% to 60%. All of the above polymers contain saturated mid-blocks that provide increased oxidation resistance, higher service temperatures and increased processing stability. The preferred primary polymers are styrene-ethylene/propylene (SEP) block co-polymer and styrene-ethylene/butylene (SEB) block co-polymer, which provide more balanced adhesive and cohesive strengths over a broad range of temperatures. The primary elastomer polymers typically are blended with a tackifying resin, either by the supplier or during extrusion. The tackifying resin provides the initial surface contact to textured surfaces while the thermoplastic elastomers provide the cohesive strength. The tackifying resin should be present in an amount within the range of from about 10-60% of the final formulation by weight, preferably 20-40%. Below 10%, there is no initial adhesion—without adding heat to soften the film and make it more conformable to the textured surface. Above 60%, the film may stick to the processing rollers during extrusion. Using the guidelines provided herein, those skilled in the art will be capable of designing a suitable polymer or polymer mixture for use in forming the masking film of the invention.

Secondary polymers such as polyolefins (homopolymers or co-polymers), polyvinyl alcohol, polyvinyl chloride, nylon, polyester, styrenes, butylenes, polymethylpentene and polyoximethylene, and mixtures thereof, can be blended with the primary polymer (e.g., SEBS) at varying ratios to provide the desired level of adhesion of the film. Acid-modified co-polymers, anhydride-modified co-polymers and acid/acrylate-modified co-polymers also are useful. Films of polyethylene are particularly suited and therefore preferred. Films of low-density polyethylene homopolymers are even more particularly suited, and therefore more preferred, due to their relatively low flexure modulus which tends to conform better to surfaces.

The ratio of thermoplastic adhesiveless layer to embossed layer in the multi-layer masking film of the present invention varies depending upon the desired characteristics of the multi-layer masking film. It is within the contemplated scope of the present invention that the ratios can be varied to accommodate needs for abrasion resistance, stiffness, tensile strength, peel strength and the like. The two layer masking film of the present invention is especially useful in such end use applications where the adhesiveless masking film is desired to be relatively flexible.

It also is within the contemplated scope of the present invention that at least one core film layer can be interposed between the thermoplastic adhesiveless film layer (smooth surface) and the rough film layer (e.g., embossed film). This core layer can aid in providing the desired opacity and/or color, stiffness and toughness to the multilayer masking film. The core layer used pursuant to this invention can be any of a wide variety of thermoplastic polymeric or elastomeric materials such as films made of polyethylene, polypropylene, polyvinyl chloride, nylon, polyester, and the like.

Fillers added to the core and rough layers can provide certain desired characteristics, including, for illustrative purposes only, roughness, anti-static, abrasion resistance, printability, writeability, opacity and color. Such fillers are well known in the industry and include, for example, calcium carbonate (abrasion resistance), mica (printability), titanium dioxide (color and opacity) and silicon dioxide (roughness).

In a preferred embodiment when a multiple layered film is used in the invention, the multiple layers of the masking film are co-extruded using any co-extrusion process known in the art. The use of co-extrusion allows for the relatively simple and easy manufacture of a multi-layered masking film composed of distinct layers, each performing specific functions. Although co-extrusion of the improved multi-layered masking film of the present invention is preferred, it is again noted that the masking film can be mono-layered or multi-layered and that, regardless of form, the masking film can be produced using any other suitable method, if desired.

Any of a variety of conventional methods can be utilized for applying the multi-layer (or monolayer) masking film to the textured surface of the substrate to be protected. Preferably, the multi-layer film is taken off from a roll and directly applied to the surface by means of a nip roll or similar system. In this manner, the smooth side of the multi-layer film is applied to and pressed against the textured substrate in one operation. If desired, the resulting lamination may be passed through compression rolls or the like for further processing. Other suitable techniques for forming the laminations of this invention will be readily apparent to those skilled in the art upon reading the description herein.

The present invention enables the application of a multi-layer (or monolayer) masking film to a textured surface without relying on an adhesive coating. In addition, process oils, anti-blocking agents or temperature resistant substrates are not required in the present invention. The initial adhesion to the textured surface preferably is controlled by the conformability of the film and the percentage of tackifier. The multi-layer masking film is stable over time, even when exposed to moisture, heat and ultraviolet light.

Many other variations, modifications, and alternate embodiments may be made in the article and techniques described, by those skilled in the art, without departing from the concept of the present invention. Accordingly, it should be clearly understood that the article and methods referred to in the foregoing description and following examples are illustrative only and are not intended as limitations on the scope of this invention.

### EXAMPLES

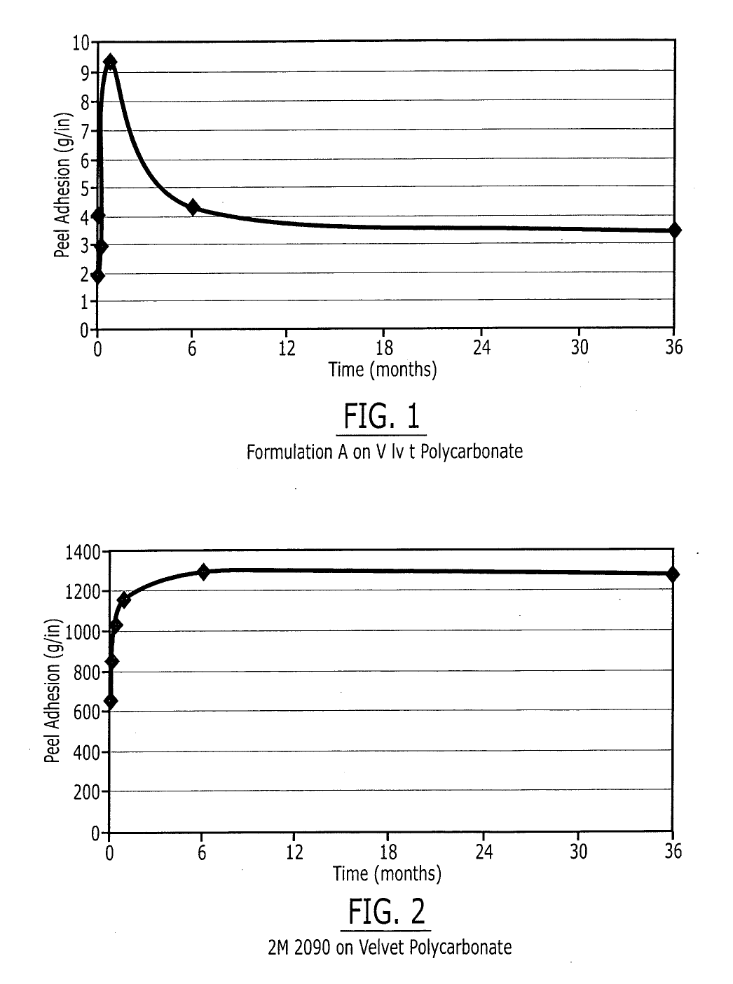

A further understanding of the masking film of the present invention can be obtained by reference to FIGS. 1-4 in connection with the following examples. FIGS. 1-4 depict graphs illustrating peel adhesion values after aging for two textured polycarbonate surfaces. Two masking films and a comparison film were measured.

Test Procedures

Two masking films were prepared by varying the percentage of styrene-ethylene/propylene (SEP) diblock—Kratone® MD-6666, commercially available from Kraton Polymers, Houston, Tex. Kraton® MD-6666 contains less than 40% tackifying hydrocarbon resin. The Kraton® MD-6666 was blended with a metallocene low-density polyethylene—SLP9518, commercially available from Exxon/Mobil Chemical Americas, Houston, Tex., to form the smooth side of the masking films. The core and rough layers were 100% low-density polyethylene—NA217, commercially available from from Equistar, Houston, Tex. The ratio of smooth to core to rough layers was 25% to 50% to 25%. The formulations were cast onto a polished chrome roll with a temperature of 75° F. A secondary cooling roll at 80° F. was also used. The rubber roll was 27 Ra high release silicone at 80° F. The basis weight of the masking films was 46.7 gsm with a gauge of 2 mils.

In Formulation A, the smooth layer ratio was 50% Kraton® MD6666 and 50% metallocene low density polyethylene. In Formulation B, the ratio was 80% Kraton® MD-6666 and 20% metallocene low-density polyethylene. The comparison masking film was 3M 2090 Safe-Release®. Painters' Masking Tape, commercially available from 3M, St. Paul, Minn. 3M 2090 is a blue crepe face tape with a pressure-sensitive synthetic adhesive.

All three masking films were tested on Lexan® polycarbonate from GE Plastics, a division of General Electric Company, Pittsfield, Mass. The polycarbonate films were 10 mils (254 microns) thick with two different surface textures, velvet (#8B35) and suede (#8B36). Both were measured for surface roughness with a T4000 Surface Roughness System (LV50) from Hommel America, Inc. The three machine direction readings and three transverse direction readings were taken on each surface. The velvet had an average surface roughness of 147 Ra, with a standard deviation of 4 Ra. The suede had an average surface roughness of 580 Ra, with a standard deviation of 60 Ra.

The substrate materials were cut to 2 inch by 6 inch sheets and laminated to foam board panels of the same size. The foam board provided rigidity for handling and aging. The adhesive film samples were cut to 1.0 inch by 9.5 inch with the long side in the machine direction. All test materials were conditioned at 73±3° F. and 50±5% relative humidity for at least 24 hours prior to application and testing. Peel adhesion was tested according to a modified PSTC-101 method. The modification included the dwell time and the substrate. The tests were performed on a Cheminstruments AR-1500 Adhesion Release Tester with integral data acquisition capabilities. Exactly 1.0 inch wide samples were applied to the specified substrate at a rate of 24 in./min. with a 4½ pound rubber covered roller according to the method.

The films and tape then were peeled from the substrate at a 180 degree angle after the specified aging condition and dwell time. The force required for removal was measured and averaged. Five replicates of the each test condition were tested. Aging was performed at two conditions: 73±3° F. (23° C.) and 50±5% relative humidity and also at 140±3° F. (60° C.) and approximately 20% relative humidity. Samples were allowed to return to room temperature for two hours after elevated aging prior to testing. All tests were conducted at 73±3° F. (23° C.) and 50±5% relative humidity. According to the tape and label industry, accelerated aging at 60° C. for 7 days is equivalent to 6 months. 21 days at 60° C. is equivalent to 3 years. Results less then two grams/inch were not specifically recorded but classified <2 grams because the reading was below the sensitivity of the recording machine. The control tape on the suede substrate started to curl up during testing. The longer the high temperature dwell, the more pronounced it became. After three weeks, however, the tape still did not curl up completely.

The results of the above-identified tests are summarized in Table I below.

TABLE 1
Peel Adhesion Data (g/in)

| | Velvet Polycarbonate | | | | | | Suede Polycarbonate | | | | | |
|---|---|---|---|---|---|---|---|---|---|---|---|---|
| | | | | 3M 2090 | | | | | | 3M 2090 | | |
| | | | | Safe-Release ™ | | | | | | Safe-Release ™ | | |
| Dwell | | | | Painters' | | | | | | Painters' | | |
| Duration & | Formulation A | | | Masking Tape | | | Formulation B | | | Masking Tape | | |
| Temperature | AVG. | σ | n | AVG. | σ | n | AVG. | σ | n | AVG. | σ | n |
| 1 Minute at 23° C. | 4.1 | 0.2 | 5 | 656 | 32 | 5 | 3.1 | 0.7 | 5 | 130 | 13 | 5 |
| 24 Hours at 23° C. | <2 | — | 5 | 853 | 18 | 5 | 2.7 | 0.3 | 5 | 150 | 14 | 5 |
| 7 days at 23° C. | 2.9 | 0.2 | 5 | 1034 | 33 | 5 | 4.6 | 0.7 | 5 | 153 | 12 | 5 |
| 21 days at 23° C. | 9.4 | 1.7 | 5 | 1155 | 15 | 5 | 5.3 | 0.4 | 5 | 172 | 13 | 5 |
| 7 Days at 60° C. | 4.3 | 1.5 | 5 | 1294 | 34 | 5 | 4.4 | 1.2 | 5 | 59.1 | 18.5 | 5 |
| 21 Days at 60° C. | 3.4 | 0.7 | 5 | 1272 | 84 | 5 | 3.2 | 1.5 | 5 | 55.2 | 9.8 | 5 |

The results in the Table are shown graphically in FIGS. 1-4. The results on the velvet polycarbonate surface (FIGS. 1 and 2) reveal that Formulation A did not escalate with aging as the 3M 2090 control did. Formulation A had initial peel strength at 4.1 g/in with final peel strength of 3.4 g/in. The 2090 control increased from 656 g/in to 1272 g/in (a 94% increase). This is typical for a pressure-sensitive adhesive, in that peel adhesion force builds with increased dwell time.

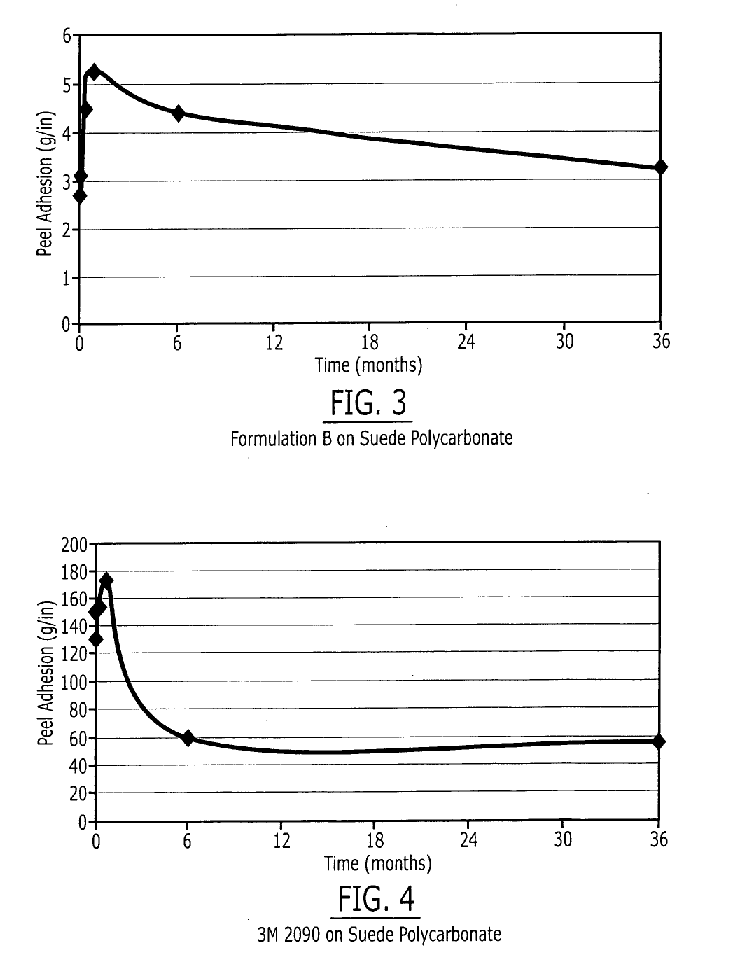

For the rougher suede polycarbonate surface, Formulation B was used. The higher percentage of diblock styrene-ethylene/propylene (SEP) co-polymer and tackifier enabled the inventive masking film to adhere to the more textured surface. See FIGS. 3 and 4.

The results on the suede polycarbonate surface (FIGS. 3 and 4) displayed that Formulation B did not escalate with aging. Formulation B had initial peel strength at 3.1 g/in with final peel strength of 3.2 g/in. The 3M 2090 control, however, started curling up from the suede polycarbonate surface and dramatically decreased from 130 g/in to 55.2 g/in (a 58% decrease).

The masking film of the present invention is thus capable of providing a controlled, adjustable and adequate level of protection to textured surfaces without an adhesive coating and its associated disadvantages. The unique advantages of the improved masking film of the present invention allow the film to be modified to meet the desired substrate's chemistry and topography

The invention has been described with reference to particularly preferred embodiments and examples. Those skilled in the art will appreciate, however, that various modifications may be made to the invention without significantly departing from the spirit and scope thereof.

1.-13. (canceled)

14. A method of adhering a masking film to a surface comprising the steps of:
(a) providing a masking film comprising a first side and a second side;
wherein
(i) said first side has a smooth, non-coated adhesive surface and comprises from about 30 wt. % to about 80 wt. % of at least one thermoplastic elastomer having saturated rubber mid-blocks selected from the group consisting of styrene-ethylene/butylene-styrene, styrene-ethylene/propylene-styrene, styrene-ethylene/butylene, and styrene-ethylene/propylene; and from about 10 wt. % to about 60 wt./ % of a tackifying resin; and
(ii) said second side has a rough surface; and
(b) removably adhering said masking film to a textured surface having a surface roughness greater than about 150 Ra.

15. The method of claim 14 wherein said textured surface has a surface roughness of from about 150 Ra to about 1000 Ra.

16. The method of claim 15 wherein said textured surface is constructed of a material selected from the group consisting of polycarbonate, polyurethane, polyester, acrylic, polyvinyl chloride, nylon, polyester, glass, ceramic, stone, and metal.

17. The method of claim 14 wherein said masking film has a peel adhesion value, with respect to said textured surface, of from about 2 to about 907 g/in at room temperature.

18. The method of claim 17 wherein said textured surface peel adhesion value does not deviate more than about 42% from its initial value when subjected to 7 to 21 days of accelerated aging.
